(19) United States
(12) Patent Application Publication
(10) Pub. No.: US 2023/0230047 A1
(43) Pub. Date: Jul. 20, 2023

(54) METHODS AND SYSTEM FOR UPDATING DEVICE MAINTENANCE PROFILES

(71) Applicant: Nuvolo Technologies Corporation, Paramus, NJ (US)

(72) Inventors: Tao Ye, Garfield, NJ (US); Murlidhar Laxminarayan, Mumbai (IN)

(21) Appl. No.: 18/096,590

(22) Filed: Jan. 13, 2023

Related U.S. Application Data
(60) Provisional application No. 63/299,623, filed on Jan. 14, 2022.

(51) Int. Cl. G06Q 10/20; G06F 16/23

(52) U.S. Cl. CPC G06Q 10/20; G06F 16/235

(57) ABSTRACT

Methods, systems, and apparatus for updating maintenance profiles of devices or equipment are disclosed herein. An updated device maintenance profile is generated based on an existing maintenance profile of a device via an operation that preserves the form logic of the former. An electronic change request is generated irrespective of the data structures in the maintenance profiles, and upon the approval of the request, the updated maintenance profile is activated as the operative maintenance profile of the device. Further, an audit trail recording the activities of the system updating the maintenance profiles of devices is generated.

### RELATED APPLICATION

This application claims priority under 35 U.S.C. § 119(e) to U.S. Provisional Patent Application No. 63/299,623 filed on Jan. 14, 2022, the entire content of which is hereby expressly incorporated by reference herein.

### TECHNICAL FIELD

This disclosure relates to methods and systems for the management of device maintenance, and more specifically to methods and system for updating device maintenance profiles.

### BACKGROUND

Devices in industrial and research laboratories have associated maintenance schedules and procedures specifying the parameters for maintaining or servicing the devices. For example, the maintenance configurations of a device can have settings for the timing, the procedures, the personnel requirements, etc., for maintaining the device. Overtime, the maintenance needs or requirements of the device may change, and the configurations may have to be updated to accommodate the changes in the needs or requirements, requiring permissions to be obtained from the relevant entities tasked with authorizing the changes.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Some embodiments of the present disclosure disclose a method comprising receiving, using at least one processor, a request to update a first maintenance profile of a device that is an operative maintenance profile of the device. Further, the method comprises receiving, using the at least one processor, a second maintenance profile of the device generated based on the first maintenance profile of the device. Further, the method comprises generating, using the at least one processor, an electronic change request (ECR) configured to request replacement of the first maintenance profile with the second maintenance profile as the operative maintenance profile of the device. In some instances, the generation of the ECR occurs automatically irrespective of a format in which first maintenance profile data of the first maintenance profile is arranged within the first maintenance profile. Further, the method comprises transmitting, using the at least one processor, the ECR to a profile change authorization server configured to regulate changes to the first maintenance profile of the device. Further, the method comprises receiving, using the at least one processor and in response to the transmitting, an authorization message from the profile change authorization server authorizing or denying the ECR.

Some embodiments of the present disclosure disclose a system, comprising: at least one computer-readable medium storing computer-executable instructions; and at least one processor configured to execute the computer executable instructions to cause the system to perform operations comprising: receiving, using at least one processor, a request to update a first maintenance profile of a device that is an operative maintenance profile of the device. The operations further comprise receiving, using the at least one processor, a second maintenance profile of the device generated based on the first maintenance profile of the device. Further, the operations further comprise generating, using the at least one processor, an electronic change request (ECR) configured to request replacement of the first maintenance profile with the second maintenance profile as the operative maintenance profile of the device, the generating the ECR occurring automatically irrespective of a format in which first maintenance profile data of the first maintenance profile is arranged within the first maintenance profile. Further, the operations further comprise transmitting, using the at least one processor, the ECR to a profile change authorization server configured to regulate changes to the first maintenance profile of the device. In addition, the operations comprise receiving, using the at least one processor and in response to the transmitting, an authorization message from the profile change authorization server authorizing or denying the ECR.

Some embodiments of the present disclosure disclose a non-transitory computer readable medium (CRM) comprising at least one program for execution by at least one processor of a system, the at least one program including instructions which, when executed by the at least one processor, cause the system to perform operations comprising: receiving, using at least one processor, a request to update a first maintenance profile of a device that is an operative maintenance profile of the device. The operations further comprise receiving, using the at least one processor, a second maintenance profile of the device generated based on the first maintenance profile of the device. Further, the operations comprise generating, using the at least one processor, an electronic change request (ECR) configured to request replacement of the first maintenance profile with the second maintenance profile as the operative maintenance profile of the device, the generating the ECR occurring automatically irrespective of a format in which first maintenance profile data of the first maintenance profile is arranged within the first maintenance profile. Further, the operations comprise transmitting, using the at least one processor, the ECR to a profile change authorization server configured to regulate changes to the first maintenance profile of the device. In addition, the operations further comprise receiving, using the at least one processor and in response to the transmitting, an authorization message from the profile change authorization server authorizing or denying the ECR.

### BRIEF DESCRIPTION OF THE DRAWINGS

FIG. 1 illustrates example computing system for updating device maintenance profiles, according to some embodiments of the present disclosure.

FIG. 2 illustrates an example flow diagram for updating device maintenance profiles, according to some embodiments of the present disclosure.

FIG. 3 illustrates an example flow diagram for generating versions of device maintenance profiles, according to some embodiments of the present disclosure.

FIG. 4 illustrates a screenshot of an example audit trail for auditing changes to device maintenance profiles, according to some embodiments of the present disclosure.

FIG. 5 is an example process for generating an electronic change request (ECR) for updating device maintenance profiles, according to some embodiments of the present disclosure.

FIG. 6 is an example process for producing versions of device maintenance profiles to generate an ECR, according to some embodiments of the present disclosure.

FIG. 7 is an example process for generating audit trails for auditing changes to device maintenance profiles, according to some embodiments of the present disclosure.

FIG. 8 is a diagram of an example computer system, according to some embodiments of the present disclosure.

Like reference numbers and designations in the various drawings indicate like elements.

### DETAILED DESCRIPTION

Equipment, such as those used in the pharmaceutical industry and educational institutions for research, production, etc., have associated therewith maintenance profiles specifying the parameters for maintaining or servicing the equipment. Such parameters include but are not limited to the frequency with which the equipment is to be serviced, the procedures to be implemented during the maintenance operations, etc. Changing the maintenance profiles and the parameters involves an authorization process that includes preparing a draft maintenance profile with the needed changes based on the active maintenance profile for review by an authorizing entity, and designating the draft maintenance profile as the active maintenance profile once authorization is obtained.

Some advantages of these techniques include the capability to generate requests to update device maintenance profiles in an efficient and scalable manner with little or no user input. In particular, maintenance profiles that may have different formats and data structures therein can be ingested into the request generator system irrespective of the formats and form of the data structures, and the requests can be generated automatically without prior input by a user, allowing the authorization requesting process to be highly scalable and efficient.

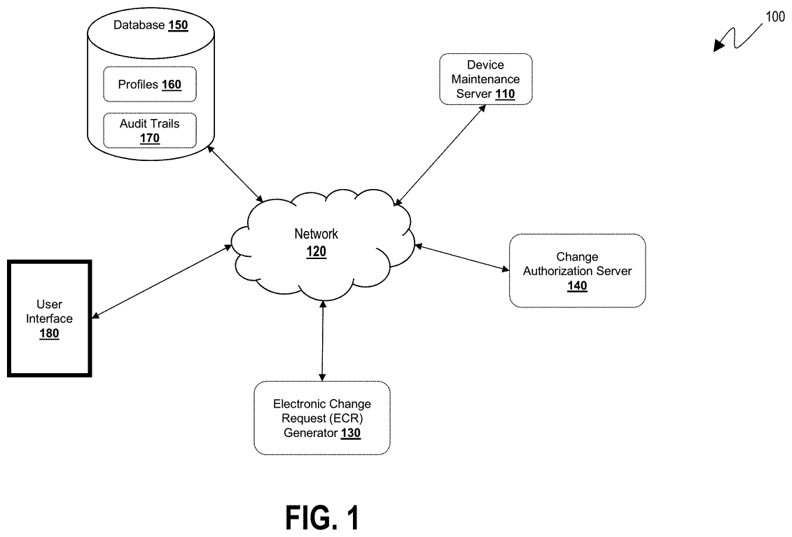

FIG. 1 illustrates example computing system 100 for updating device maintenance profiles, according to some embodiments of the present disclosure. In some embodiments, the computing system 100 includes a device maintenance server 110, an electronic change request (ECR) generator 130, a change authorization server 140, a database 150 and a user interface 180 communicatively connected to each other via a network 120. Each of the device maintenance server 110, an electronic change request (ECR) generator 130, a change authorization server 140, a database 150 and a user interface 180 includes or can be a computing device, where the computing device operates one or more operating system (e.g., Microsoft Windows, Apple OSX, Linux, Unix, Android, Apple iOS, etc.) and/or architectures (e.g., x86, PowerPC, ARM, etc.). The computing device can also be or include computers (such as desktop computers, notebook computers, server systems, etc.), mobile computing devices (such as cellular phones, smartphones, tablets, personal data assistants, notebook computers with networking capability), and other computing devices capable of transmitting and receiving data via the network 120.

In some embodiments, the network 120 can be any communications network through which data can be transferred and shared. For example, the network 120 can be a local area network (LAN) or a wide-area network (WAN), such as the Internet. The network 120 can be implemented using various networking interfaces, for instance wireless networking interfaces (such as Wi-Fi, Bluetooth, or infrared) or wired networking interfaces (such as Ethernet or serial connection). The network 120 also can include combinations of more than one network, and can be implemented using one or more networking interfaces.

In some embodiments, the device maintenance server 110 is configured to manage the maintenance of devices or equipment, which include but are not limited to industrial devices, research laboratory devices, pharmaceutical devices, materiel devices, and/or the like. A device has an associated device maintenance profile that configures maintenance operations to be performed on the device. A device maintenance profile is a data structure including one or more configurations or settings specifying the parameters for maintaining or servicing the associated device. For instance, the device maintenance profile can configure the maintenance settings such as but not limited to the frequency, the procedure, the personnel, the location, the duration, etc., for providing maintenance to the device. As a non-limiting example illustration, a pharmaceutical device such as a centrifuge may have associated therewith a device maintenance profile with a setting for the frequency (e.g., every three months, every six months, etc.) with which maintenance operations are to be performed on the centrifuge, and the procedure (e.g., good practice (GxP) procedures) to be used when performing the maintenance operations.

In some cases, those entities using or handling the device (e.g., “users” of the device) may wish to have some or all of the parameters of the maintenance operations changed. For example, a device may have been in use and being maintained for an extended period of time with little or no decreased performance, and the users of the device may decide to reduce the frequency of the maintenance operations (e.g., to reduce the cost of the operations). As another example, a device may be showing signs of aging, and the users may decide to increase the frequency and/or the procedures of the maintenance operations. For instance, the users may decide more frequent and intensive or detailed maintenance operations are appropriate for such devices.

In such cases, the users may utilize the device maintenance server 110 to manage the maintenance of devices, for instance, to request authorization to change the parameters of the maintenance operations of a device. For example, the users may use the device maintenance server 110 to transmit a request to an electronic change request (ECR) generator 130 for the latter to generate and transmit to the change authorization server 140 an ECR requesting changes to the configurations or parameters of maintenance operations that are to be performed on the device. In some instances, the request may include the active device maintenance profile of the device, i.e., the device maintenance profile that is in effect at the time. For example, the database 150 may store device maintenance profiles 160 including the active device maintenance profile of the device, and the device maintenance server 110 can extract this active device maintenance profile from the database 150 and transmit it to the ECR generator 130 with the request for the changing of the maintenance operations parameters.

In some embodiments, upon receiving the request, which may include the active device maintenance profile, from the device maintenance server 110, the ECR generator 130 generates the ECR and transmits the same to an authorizing entity that is tasked with overseeing changes to device maintenance profiles of devices. The ECR can include the updated device maintenance profile that is proposed as a replacement for the active device maintenance profile and a request that the authorizing entity approve the replacement of the active device maintenance profile by the updated device maintenance profile (e.g., retire the active device maintenance profile and render the updated device maintenance profile as the operative device maintenance profile of the device). In some instances, the ECR generator 130 generates an updated device maintenance profile that includes the desired configuration or parameter changes (e.g., updated parameter for the frequency of maintenance operations, updated or modified procedures for performing the maintenance operations, etc.). The ECR generator 130 then generates the ECR including the updated or replacement device maintenance profile, with the ECR including a request that the authorizing entity approve the replacement of the active device maintenance profile with the updated device maintenance profile as the operative device maintenance profile of the device. The ECR generator 130 can then transmit, e.g., via the network 120, the ECR along with the updated device maintenance profile to the change authorization server 140 of the authorizing entity.

In some embodiments, the change authorization server 140 is configured to be used by said authorizing entity to evaluate the ECRs and approve or deny the request for elevating the updated/modified device maintenance profile as the operative device maintenance profile of the device. In some instances, the authorizing entity may perform appropriate due diligence before determining whether to approve or deny the ECR. For example, the change authorization server 140 may check to determine whether the request for the device maintenance profile replacement complies with various regulations, cost constraints, etc. The authorizing entity can then use the change authorization server 140 to transmit the authorization or denial message to the ECR generator 130.

In some embodiments, upon receiving an authorization message from the change authorization server 140 approving the ECR, the ECR generator 130 elevates the updated or modified device maintenance profile as the operative device maintenance profile. For example, the ECR generator 130 can retire or deactivate the active device maintenance profile of the device and activate the updated or modified device maintenance profile to replace the deactivated device maintenance profile as the operative device maintenance profile. The ECR generator 130 can then store the deactivated and the updated device maintenance profiles in profiles 160 of the database 150 as a retired and active/operative device maintenance profiles of the device, respectively.

In some embodiments, the ECR generator 130 (e.g., or another computing server of the system 100) may generate an audit trail of the replacement of the device maintenance profile for use in auditing changes made to device maintenance profiles. The audit trail is a record of activities of system 100, and components thereof such as but not limited to the device maintenance server 110, the change authorization server 140, the ECR generator 130, etc.), that relate to the process of replacing the deactivated device maintenance profile by the updated device maintenance profile as the operative device maintenance profile. For example, the audit trail may include some or all of the information related to the replacement of the deactivated device maintenance profile with the updated device maintenance profile as the operative device maintenance profile of the device, such information including but not limited to the identity of the user of the device maintenance server 110 that requested the changes to the maintenance operation parameters, identifiers of the device maintenance server 110, the ECR generator 130, and the change authorization server 140 used in obtaining approval for the replacement of the device maintenance profile, timestamps of the deactivation and activation of the device maintenance profiles, identifiers of the deactivated and activated device maintenance profiles, and/or the like.

In some embodiments, the audit trail includes a field configured to hold information related to the ECR that requested the replacement of the active device maintenance profile (e.g., and resulted in the deactivation of the active device maintenance profile and activation of the updated device maintenance profile). In some instances, the ECR generator 130 extracts the ECR-related information from the ECR and populates the field in the audit trail with the extracted information. For example, the ECR generator 130 can extract ECR-identifying information from the ECR and populate the field with the extracted information, examples of such information including but not limited to a serial number of the ECR, etc. In some instances, the field in the audit trail may include information identifying the reason for the replacement of the device maintenance profile. For example, the information in the field may identify the ECR itself as the reason for the device maintenance profile, and/or identify the reason (e.g., by the user of the device maintenance server 110) to request for the change in the maintenance operations parameter (e.g., the reason being the request by the user to increase or decrease the frequency of the maintenance operations). In some cases, the ECR generator 130 may extract or otherwise obtain this information from the ECR.

In some embodiments, the ECR generator 130 displays the audit trail in a user interface 180 that is communicatively connected to the ECR generator 130 via the network 120. In some instances, the user interface 180 may be configured to receive user input. For example, the user interface 180 may be configured to allow a user enter the information related to the ECR directly into the field in the audit trail displayed on the user interface 180 (e.g., if the field is not populated with the information already) or modify information that already exists in the field. In some instances, the user interface 180 may allow a user to enter or modify information in the field, while disabling the modification of any other information contained within the audit trail. In some instances, the user interface 180 may be configured to display the audit trail for viewing purposes without allowing a user to modify the information contained therein or input any additional information into the audit trail. The ECR generator 130 stores the audit trails in the audit trails 170 of the database 150 (e.g., for use in auditing changes to device maintenance profiles).

In some embodiments, as discussed above, the database 150 may be configured to store device maintenance profiles 160 and/or audit trails 170. Database 150 stores data that is transmitted to, received from, generated and/or updated by device maintenance server 110, change authorization server 140, and/or ECR generator 130. In some examples, database 150 includes a storage component that stores data and/or software related to the operation, and uses at least one device or server of, system 100. In some embodiments, database 150 can be implemented across a plurality of devices. For example, database 150 can be implemented in one or more of the device maintenance server 110, the change authorization server 140, the ECR generator 130, and/or the user interface 180.

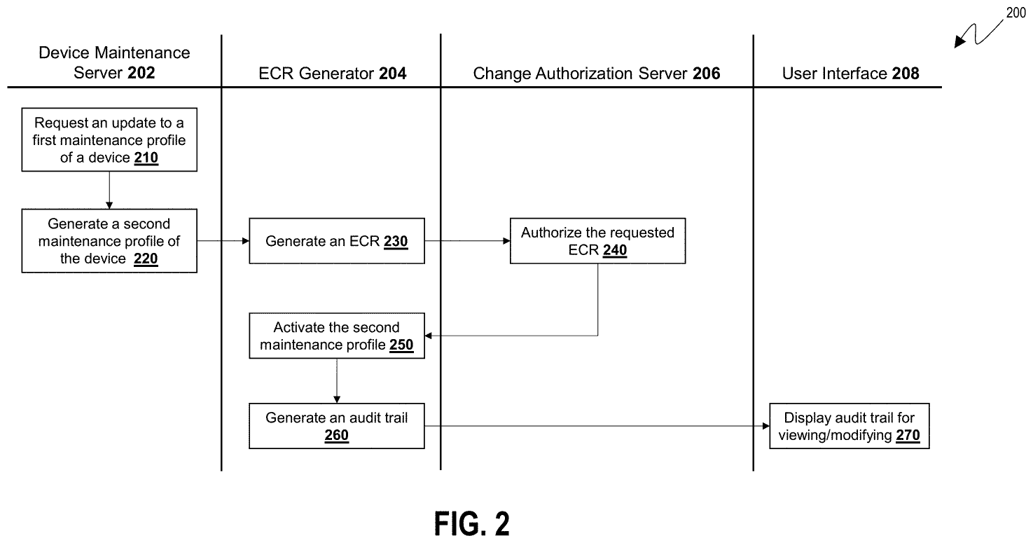

FIG. 2 illustrates an example flow diagram 200 for updating device maintenance profiles, according to some embodiments of the present disclosure. At 210, a device maintenance server 202 sends a request to an ECR generator 204 requesting a first device maintenance profile that is the operative maintenance profile of a device to be updated. For example, the first device maintenance profile that is active or in effect at the time may be outdated and the request from the device maintenance server 202 to the ECR generator 204 may identify the configurations or settings to be updated or modified in a new second device maintenance profile that is to replace the first device maintenance profile as the operative maintenance profile of the device.

At 220, a device maintenance server 202 also generates a second maintenance profile of a device based on the first maintenance profile of the device, where the former is the proposed device maintenance profile to replace the latter as the operative maintenance profile of the device, and transmit the same to the ECR generator 204 along with the request. In some embodiments, in addition to or instead of the device maintenance server 202 generating the second maintenance profile, the ECR generator 204 may generate the second maintenance profile. The second device maintenance profile includes updated parameters (e.g., in comparison to those in the first device maintenance profile) for the configurations or settings identified in the request from the device maintenance server 202. For example, if the request from the device maintenance server 202 requests that the frequency of device maintenance operations be lowered from once every three months to once every six months, the second device maintenance profile is generated by updating the parameter of the frequency configuration or setting in the second device maintenance profile from three months to six months.

In some embodiments, the generation of the second maintenance profile of the device based on the first device maintenance profile preserves a characteristic of a format of a data structure in which first maintenance profile data of the first device maintenance profile is arranged within the first device maintenance profile. In some instances, data of the first device maintenance profile is arranged within the first device maintenance profile in a data structure having a format, and characteristics of the data structure, or the format thereof, are maintained or preserved when the second device maintenance profile is generated. For example, the data structure in which the first maintenance profile data is arranged within the first device maintenance profile can be a table with a tabular format (e.g., of a given size, shape, etc.). In such cases, a characteristic of the table can be the type of a field or element of the table, a form logic relating the different fields of the table, etc. For example, the table can have fields with data types such as but not limited to texts, numbers, currencies, rich texts (e.g., with color, font control, etc.), dates/times, images, hyperlinks, tables, and/or the like. Further, the table can have a form logic establishing relationships between the various fields in the table, such as but not limited to one-to-one relationship (e.g., one field or a set of fields related to another field), one-to-many relationship, many-to-many relationship, etc.

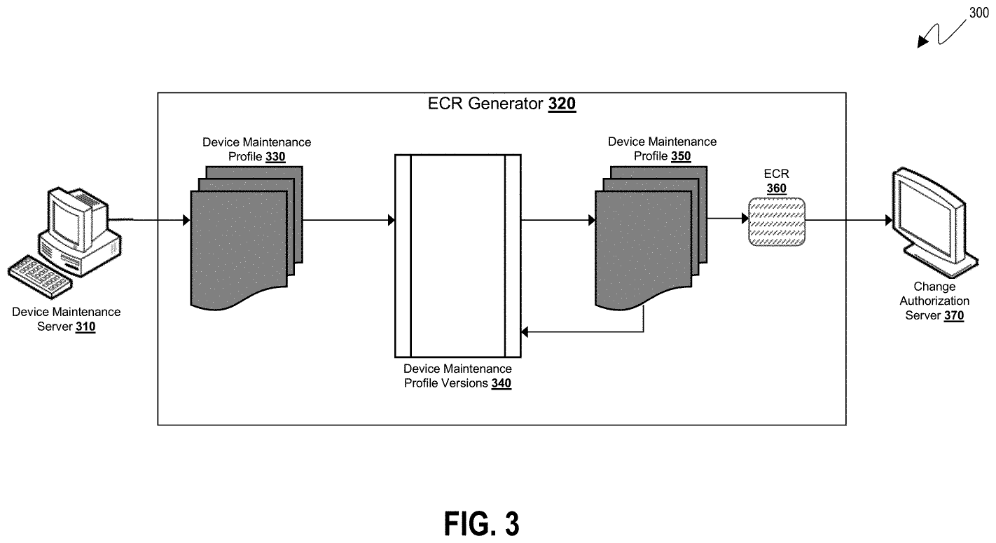

In some embodiments, the generation of the second maintenance profile of the device preserves the characteristics of the data structure in the first device maintenance profile by initially converting, via an operation that preserves the characteristics, the first device maintenance profile into a version of the device maintenance profile and then editing the converted version to the second device maintenance profile. FIG. 3 illustrates an example flow diagram 300 for generating versions of device maintenance profiles, according to some embodiments of the present disclosure. In some embodiments, after the generation of the request by the device maintenance server 310 that includes the first maintenance profile 330 of the device, the device maintenance server 310 and/or the ECR generator 320 perform a flattening operation on the first device maintenance profile 330 to generate a flattened device maintenance profile, which can be stored in a versions table 340 that contains or references versions of device maintenance profiles. The flattening operation preserves the characteristics (e.g., type of fields, form logic of the table, etc.) of the first device maintenance profile 330 in that the version of the device maintenance profile 330 that is flattened includes device maintenance profile data sharing the same characteristics as that of the first device maintenance profile 330 but having different formats than the format of the data in the first device maintenance profile 330. For example, the data in the first device maintenance profile 330 can be arranged in a tabular data structure with the aforementioned characteristics. In such cases, the flattening operation may generate a flattened device maintenance profile in a different file format but including the data having the same characteristics. An example of such flattening operation is an operation that converts the first device maintenance profile 330, which may be in a tabular format, to a JavaScript Object Notation (JSON) file format.

In some embodiments, the second device maintenance profile 350 can then be generated from the flattened device maintenance profile located in the versions table 340 by editing the flattened device maintenance profile to include the changes in configurations or settings of device maintenance operations requested in the request from the device maintenance server 310. The changes can be included in the second device maintenance profile 350 by editing the parameters of those configurations or settings in the flattened device maintenance profile. For example, as discussed above, the request from the device maintenance server 310 may request that the frequency and/or procedure of a device maintenance operation that is to be performed on a device be adjusted. In such cases, the second device maintenance profile 350 can be generated by editing or changing the parameters in the flattened device maintenance profile that specify the frequency and/or procedure to the desired values (e.g., an increased or decreased device maintenance operation frequency value). In some instances, the second device maintenance profile 350 can also be stored in the versions table 340 as another maintenance profile version of the device.

Returning now to FIG. 2, in some embodiments, at 240, the ECR generator 204 generates the ECR based on the second maintenance profile of the device that is generated by the ECR generator 204 based on the first device maintenance profile. The ECR includes the generated second maintenance profile of the device and is configured to request the change authorization server 206 for approval of the replacement of the first device maintenance profile with the second device maintenance profile. In FIG. 3, this is shown by the generation of the ECR 360 by the ECR generator 320 based on the second maintenance profile 350 of the device and the transmission of the ECR 360, which includes the second device maintenance profile 350, to the change authorization server 370 for approval by the change authorization server 370 to replace the first device maintenance profile by the second device maintenance profile as the operative maintenance profile of the device.

In some embodiments, the generation of the second maintenance profile of the device at 220 and/or the generation of the ECR at 230 occur automatically irrespective of the format in which data in the first maintenance profile is arranged within the first maintenance profile. That is, upon receiving the request from the device maintenance server 202, the ECR generator 204 performs the generation of the second device maintenance profile at 220 and/or the generation of the ECR at 230 without input from a user and/or irrespective of the arrangement of the data structures in the first maintenance profile holding the first maintenance profile data. For instance, the types of the data structures can be tables of different sizes and shapes, lists of different lengths, tree structures, etc., and the ECR generator 204 generates the second device maintenance profile at 220 and/or the ECR without user input regardless of the type of the data structure (e.g., the ECR generator 204 performs step 220 and/or step 230 automatically without user input regardless of the data structure in the first device maintenance profile). The capability of the ECR generator 204 to generate the second device maintenance profile and/or the ECR automatically irrespective of the format of the data structure in the first maintenance profile makes the process 200 for updating device maintenance profiles scalable and highly efficient, because step 220 and step 240 can be performed without the need for user input and for any type of device maintenance profile (e.g., for device maintenance profiles having any type of data structures).

In some embodiments, the change authorization server 206 transmits an authorization message back to the ECR generator 204 approving or denying the ECR. Upon receiving an authorization message approving the requested replacement of the first device maintenance profile by the second device maintenance profile as the operative maintenance profile of the device, at 250, the ECR generator 204 retires or deactivates the first device maintenance profile and activates the second device maintenance profile to become the operative maintenance profile of the device, replacing the first device maintenance profile.

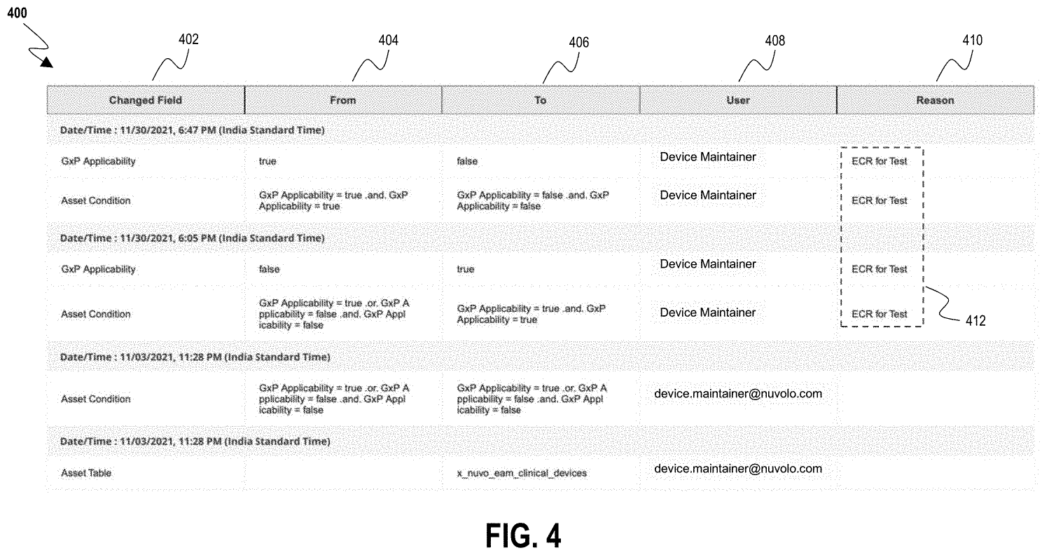

In some embodiments, at 260, the ECR generator 204 generates an audit trail of the process 200 for updating device maintenance profiles. At 270, the audit trail can be displayed on the user interface 208 to allow a user to view, augment or modify the contents in the audit trail. FIG. 4 illustrates a screenshot of an example audit trail 400 for auditing changes to device maintenance profiles, according to some embodiments of the present disclosure. The audit trail 400 contains a record of the activities of process 200 for updating device maintenance profiles, as well as information related to said activities. For example, the audit trail 400 includes an indication of the configurations or settings 402 that are changed when the operative maintenance profile of the device is changed from the first to the second device maintenance profile, the initial parameters 404 specifying the configurations or settings 402 and the updated parameters 406 to which the initial parameters 404 are updated, a user identifier 408 identifying the entity requesting the update to the device maintenance profile, a timestamp identifying the time the second device maintenance profile was updated, etc. In some instances, the audit trail 400 can also include information 410 related to the ECR that requested authorization for the replacement of the operative maintenance profile, such information identifying the ECR as the reason 412 for replacement. For example, the ECR generator 210 can extract the information from the ECR and populate the ECR-related fields in the audit trail 400 with the information.

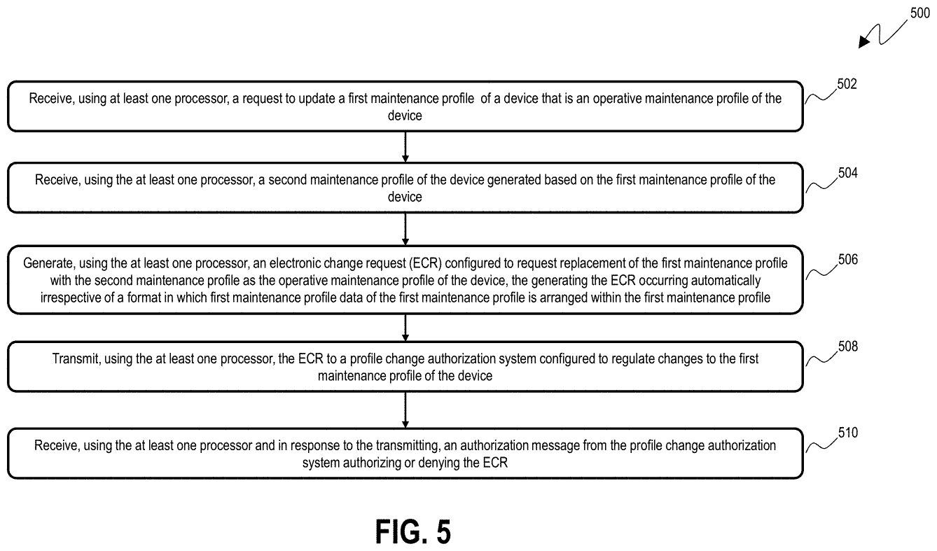

Referring now to FIG. 5, illustrated is a flowchart of a process 500 for generating audit trails for auditing changes to device maintenance profiles, according to some embodiments of the present disclosure. In some embodiments, one or more of the steps described with respect to process 500 are performed (e.g., completely, partially, and/or the like) by the device maintenance system 110, 202, 310, the ECR generator 130, 204, 320, and/or the change authorization system 140, 206, 360.

At block 502, in some embodiments, at least one processor receives a request to update a first maintenance profile of a device that is an operative maintenance profile of the device. In some instances, the first maintenance profile data of the first maintenance profile includes at least one setting configuring a maintenance operation to be performed on the device.

At block 504, in some embodiments, the at least one processor receives a second maintenance profile of the device generated based on the first maintenance profile of the device. In some instances, the at least one setting has a first value; and the generation of the second maintenance profile includes generating the second maintenance profile with a second maintenance profile data, the second maintenance profile data including the at least one setting with a second value that is different from the first value. In some instances, the at least one setting configures a frequency and/or a procedure of the maintenance operation to be performed on the device.

In some instances, the second maintenance profile data is generated via a flattening operation on the first maintenance profile that is configured to preserve a form logic of the format in which the first maintenance profile data of the first maintenance profile is arranged within the first maintenance profile; and editing of the flattened first maintenance profile to generate the second maintenance profile. In some instances, the format is a tabular format; and the form logic of the first maintenance profile data includes a functional relationship relating fields of the first maintenance profile data in the tabular format. In some instances, the flattening operation includes converting the first maintenance profile data from the format in which the first maintenance profile data of the first maintenance profile is arranged within the first maintenance profile to a JavaScript Object Notation (JSON) file format.

At block 506, in some embodiments, the at least one processor generates an electronic change request (ECR) configured to request replacement of the first maintenance profile with the second maintenance profile as the operative maintenance profile of the device. In some instances, the generation of the ECR occurs automatically irrespective of a format in which first maintenance profile data of the first maintenance profile is arranged within the first maintenance profile.

At block 508, in some embodiments, the at least one processor transmits the ECR to a profile change authorization system configured to regulate changes to the first maintenance profile of the device.

At block 510, in some embodiments, the at least one processor receives an authorization message from the profile change authorization system authorizing or denying the ECR in response to the transmission of the ECR. In some instances, the authorization message authorizes the ECR, and the process 500 further comprises activating, using the at least one processor, the second maintenance profile to replace the first maintenance profile as the operative maintenance profile of the device.

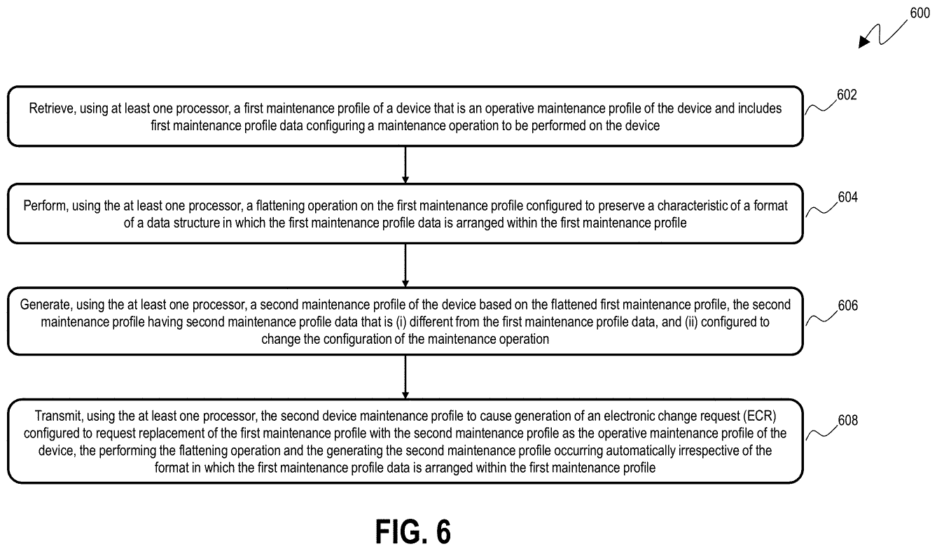

Referring now to FIG. 6, illustrated is a flowchart of a process 600 for generating audit trails for auditing changes to device maintenance profiles, according to some embodiments of the present disclosure. In some embodiments, one or more of the steps described with respect to process 600 are performed (e.g., completely, partially, and/or the like) by the device maintenance system 110, 202, 310, the ECR generator 130, 204, 320, and/or the change authorization system 140, 206, 360.

At block 602, in some embodiments, at least one processor retrieves a first maintenance profile of a device that is an operative maintenance profile of the device and includes first maintenance profile data configuring a maintenance operation to be performed on the device. In some instances, the configuration of the maintenance operation includes a frequency and/or a procedure of the maintenance operation.

At block 604, in some embodiments, the at least one processor performs a flattening operation on the first maintenance profile configured to preserve a characteristic of a format of a data structure in which the first maintenance profile data is arranged within the first maintenance profile. In some instances, the data structure is a table, the format is a tabular format, and the flattening operation including converting the first maintenance profile data from the tabular format to a JavaScript Object Notation (JSON) file format. In some instances, the characteristic of the format includes a form logic and/or a field type of the data structure.

At block 606, in some embodiments, the at least one processor generates a second maintenance profile of the device based on the flattened first maintenance profile, the second maintenance profile having second maintenance profile data that is (i) different from the first maintenance profile data, and (ii) configured to change the configuration of the maintenance operation. In some instances, the flattening operation and the generation of the second maintenance profile occur automatically irrespective of the format in which the first maintenance profile data is arranged within the first maintenance profile.

In some instances, the generation of the second maintenance profile includes editing the converted first maintenance profile data in the JSON file format to generate the second maintenance profile data that is different from the first maintenance profile data.

At block 606, in some embodiments, the at least one processor generates a second maintenance profile of the device based on the flattened first maintenance profile, the second maintenance profile having second maintenance profile data that is (i) different from the first maintenance profile data, and (ii) configured to change the configuration of the maintenance operation.

At block 608, in some embodiments, the at least one processor transmits the second maintenance profile to cause generation of an electronic change request (ECR) configured to request replacement of the first maintenance profile with the second maintenance profile as the operative maintenance profile of the device. In some instances, the operative maintenance profile of the device is configured to be unmodifiable without approval of the ECR by a profile change authorization system configured to regulate modifications to the operative maintenance profile of the device.

In some instances, the data structure is a first table and process 600 further comprises storing, using the at least one processor, the flattened first maintenance profile and the second maintenance profile in a second table that is separate from, but references, the first table.

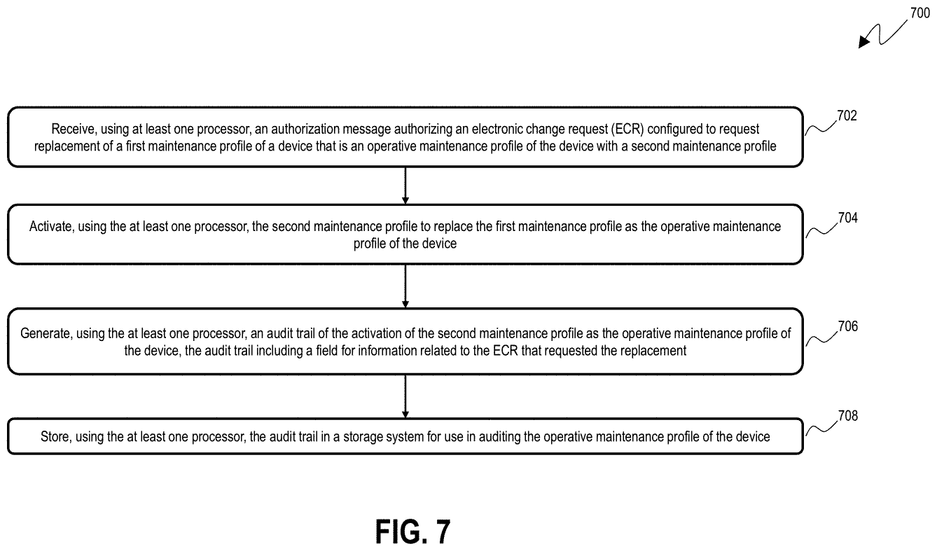

Referring now to FIG. 7, illustrated is a flowchart of a process 700 for generating audit trails for auditing changes to device maintenance profiles, according to some embodiments of the present disclosure. In some embodiments, one or more of the steps described with respect to process 700 are performed (e.g., completely, partially, and/or the like) by the ECR generator 130, 204, 320, and/or the user interface 180, 208.

At block 702, in some embodiments, at least one processor receives an authorization message authorizing an electronic change request (ECR) configured to request replacement of a first maintenance profile of a device that is an operative maintenance profile of the device with a second maintenance profile. In some instances, the operative maintenance profile of the device configures a maintenance operation to be performed on the device.

At block 704, in some embodiments, the at least one processor activates the second maintenance profile to replace the first maintenance profile as the operative maintenance profile of the device. In some instances, the replacement of the first maintenance profile by the second maintenance profile as the operative maintenance profile of the device occurs automatically irrespective of a format in which first maintenance profile data of the first maintenance profile is arranged within the first maintenance profile. In some instances, the replacement of the first maintenance profile by the second maintenance profile as the operative maintenance profile of the device changes a frequency and/or a procedure of the maintenance operation to be performed on the device.

At block 706, in some embodiments, the at least one processor generates an audit trail of the activation of the second maintenance profile as the operative maintenance profile of the device, the audit trail including a field for information related to the ECR that requested the replacement. In some instances, the information indicates a difference between the first maintenance profile and the second maintenance profile.

At block 708, in some embodiments, the at least one processor stores the audit trail in a storage system for use in auditing the operative maintenance profile of the device.

In some embodiments, process 700 further comprises extracting, using the at least one processor, the information from the ECR, and populating the field with the extracted information. In some embodiments, process 700 further comprises displaying, using the at least one processor, the audit trail in a user interface configured to allow a user augment the information related to the ECR that requested the replacement.

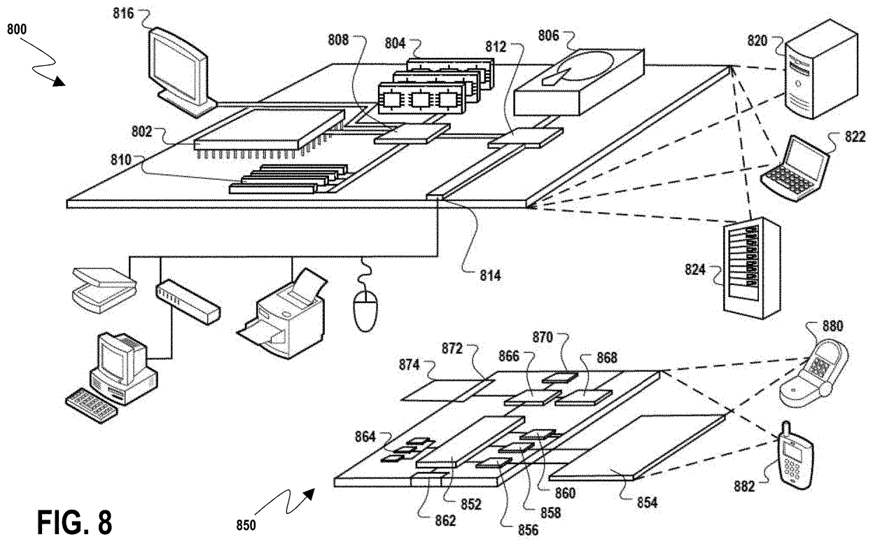

FIG. 8 is a block diagram of computing devices 800, 850 that may be used to implement the systems and methods described in this document, as either a client or as a server or plurality of servers. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a non-transitory computer-readable medium. In one implementation, the memory 804 is a volatile memory unit or units. In another implementation, the memory 804 is a non-volatile memory unit or units.

The storage device 806 is capable of providing mass storage for the computing device 800. In one implementation, the storage device 806 is a non-transitory computer-readable medium. In various different implementations, the storage device 806 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a non-transitory computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of duties is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device, such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can process instructions for execution within the computing device 850, including instructions stored in the memory 864. The processor may also include separate analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a thin-film-transistor liquid-crystal display (TFT LCD) display or an organic light-emitting diode (OLED) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication (e.g., via a docking procedure) or for wireless communication (e.g., via Bluetooth or other such technologies).

The memory 864 stores information within the computing device 850. In one implementation, the memory 864 is a non-transitory computer-readable medium. In one implementation, the memory 864 is a volatile memory unit or units. In another implementation, the memory 864 is a non-volatile memory unit or units. Expansion memory 874 may also be provided and connected to device 850 through expansion interface 872, which may include, for example, a SIMM card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS receiver module 870 may provide additional wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any non-transitory signal used to provide machine instructions and/or data to a programmable processor.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A method comprising:
receiving, using at least one processor, a request to update a first maintenance profile of a device that is an operative maintenance profile of the device;
receiving, using the at least one processor, a second maintenance profile of the device generated based on the first maintenance profile of the device;
generating, using the at least one processor, an electronic change request (ECR) configured to request replacement of the first maintenance profile with the second maintenance profile as the operative maintenance profile of the device, the generating the ECR occurring automatically irrespective of a format in which first maintenance profile data of the first maintenance profile is arranged within the first maintenance profile;
transmitting, using the at least one processor, the ECR to a profile change authorization server configured to regulate changes to the first maintenance profile of the device; and
receiving, using the at least one processor and in response to the transmitting, an authorization message from the profile change authorization server authorizing or denying the ECR.

2. The method of claim 1, wherein the first maintenance profile data of the first maintenance profile includes at least one setting configuring a maintenance operation to be performed on the device.

3. The method of claim 2, wherein:
the at least one setting has a first value; and
second maintenance profile data of the second maintenance profile includes the at least one setting with a second value that is different from the first value.

4. The method of claim 1, wherein the at least one setting configures a frequency and/or a procedure of the maintenance operation to be performed on the device.

5. The method of claim 1, wherein the authorization message authorizes the ECR, the method further comprising:
activating, using the at least one processor, the second maintenance profile to replace the first maintenance profile as the operative maintenance profile of the device.

6. The method of claim 1, wherein the second maintenance profile is generated based on the first maintenance profile of the device via:
a flattening operation on the first maintenance profile that is configured to preserve a form logic of the format in which the first maintenance profile data of the first maintenance profile is arranged within the first maintenance profile; and
editing of the flattened first maintenance profile to generate the second maintenance profile.

7. The method of claim 6, wherein:
the format is a tabular format; and
the form logic of the first maintenance profile data includes a functional relationship relating fields of the first maintenance profile data in the tabular format.

8. The method of claim 6, wherein the flattening operation includes converting the first maintenance profile data from the format in which the first maintenance profile data of the first maintenance profile is arranged within the first maintenance profile to a JavaScript Object Notation (JSON) file format.

9. A system comprising:
at least one computer-readable medium storing computer-executable instructions; and
at least one processor configured to execute the computer executable instructions to cause the system to perform operations comprising:
receiving, using at least one processor, a request to update a first maintenance profile of a device that is an operative maintenance profile of the device;
receiving, using the at least one processor, a second maintenance profile of the device generated based on the first maintenance profile of the device;
generating, using the at least one processor, an electronic change request (ECR) configured to request replacement of the first maintenance profile with the second maintenance profile as the operative maintenance profile of the device, the generating the ECR occurring automatically irrespective of a format in which first maintenance profile data of the first maintenance profile is arranged within the first maintenance profile;
transmitting, using the at least one processor, the ECR to a profile change authorization server configured to regulate changes to the first maintenance profile of the device; and
receiving, using the at least one processor and in response to the transmitting, an authorization message from the profile change authorization server authorizing or denying the ECR.

10. The system of claim 9, wherein the first maintenance profile data of the first maintenance profile includes at least one setting configuring a maintenance operation to be performed on the device.

11. The system of claim 10, wherein:
the least one setting has a first value; and
second maintenance profile data of the second maintenance profile includes the at least one setting with a second value that is different from the first value.

12. The system of claim 10, wherein the at least one setting configures a frequency and/or a procedure of the maintenance operation to be performed on the device.

13. The system of claim 9, wherein the authorization message authorizes the ECR, the operations further comprising:
activating, using the at least one processor, the second maintenance profile to replace the first maintenance profile as the operative maintenance profile of the device.

14. The system of claim 9, wherein the second maintenance profile is generated based on the first maintenance profile of the device via:
a flattening operation performed on the first maintenance profile that is configured to preserve a form logic of the format in which the first maintenance profile data of the first maintenance profile is arranged within the first maintenance profile; and
editing of the flattened first maintenance profile to generate the second maintenance profile.

15. The system of claim 14, wherein:
the format is a tabular format; and
the form logic of the first maintenance profile data includes a functional relationship relating fields of the first maintenance profile data in the tabular format.

16. The system of claim 14, wherein the flattening operation includes converting the first maintenance profile data from the format in which the first maintenance profile data of the first maintenance profile is arranged within the first maintenance profile to a JavaScript Object Notation (JSON) file format.

17. A non-transitory computer readable medium comprising at least one program for execution by at least one processor of a system, the at least one program including instructions which, when executed by the at least one processor, cause the system to perform operations comprising:
receiving, using at least one processor, a request to update a first maintenance profile of a device that is an operative maintenance profile of the device;
receiving, using the at least one processor, a second maintenance profile of the device generated based on the first maintenance profile of the device;
generating, using the at least one processor, an electronic change request (ECR) configured to request replacement of the first maintenance profile with the second maintenance profile as the operative maintenance profile of the device, the generating the ECR occurring automatically irrespective of a format in which first maintenance profile data of the first maintenance profile is arranged within the first maintenance profile;
transmitting, using the at least one processor, the ECR to a profile change authorization server configured to regulate changes to the first maintenance profile of the device; and
receiving, using the at least one processor and in response to the transmitting, an authorization message from the profile change authorization server authorizing or denying the ECR.

18. The non-transitory computer readable medium of claim 17, wherein the first maintenance profile data of the first maintenance profile includes at least one setting configuring a maintenance operation to be performed on the device.

19. The non-transitory computer readable medium of claim 18, wherein:
the least one setting has a first value; and
second maintenance profile data of the second maintenance profile includes the at least one setting with a second value that is different from the first value.

20. The non-transitory computer readable medium of claim 18, wherein the at least one setting configures a frequency and/or a procedure of the maintenance operation to be performed on the device.

21. The non-transitory computer readable medium of claim 17, wherein the authorization message authorizes the ECR, the operations further comprising:
activating, using the at least one processor, the second maintenance profile to replace the first maintenance profile as the operative maintenance profile of the device.

22. The non-transitory computer readable medium of claim 17, wherein the second maintenance profile is generated based on the first maintenance profile of the device via:
a flattening operation performed on the first maintenance profile that is configured to preserve a form logic of the format in which the first maintenance profile data of the first maintenance profile is arranged within the first maintenance profile; and
editing of the flattened first maintenance profile to generate the second maintenance profile.

23. The non-transitory computer readable medium of claim 22, wherein:
the format is a tabular format; and
the form logic of the first maintenance profile data includes a functional relationship relating fields of the first maintenance profile data in the tabular format.

24. The non-transitory computer readable medium of claim 22, wherein the flattening operation includes converting the first maintenance profile data from the format in which the first maintenance profile data of the first maintenance profile is arranged within the first maintenance profile to a JavaScript Object Notation file format.
